(19) United States
(12) Patent Application Publication
(10) Pub. No.: US 2016/0006912 A1
(43) Pub. Date: Jan. 7, 2016

(54) CAMERA MODULE

(71) Applicant: SAMSUNG ELECTRO-MECHANICS CO., LTD., Suwon-si (KR)

(72) Inventor: Sung-Hoon KIM, Suwon-Si (KR)

(73) Assignee: SAMSUNG ELECTRO-MECHANICS CO., LTD.

(21) Appl. No.: 14/567,759

(22) Filed: Dec. 11, 2014

(30) Foreign Application Priority Data
Jul. 2, 2014 (KR) 10-2014-0082546

(51) Int. Cl. H04N 5/225

(52) U.S. Cl. CPC H04N 5/2254; H04N 5/2252

(57) ABSTRACT

A camera module is disclosed. The camera module in accordance with an aspect of the present invention can include a housing having a receiving portion formed therein and a lens barrel being inserted into the receiving portion, and a rib can be formed on an inside surface of the receiving portion, and an insertion groove can be formed on an outside surface of the lens barrel in an latitudinal direction in such a way that the lens barrel is engaged with the housing by inserting the rib into the insertion groove.

### CROSS-REFERENCE TO RELATED APPLICATIONS

This application claims the benefit of Korean Patent Application No. 10-2014-0082546, filed with the Korean Intellectual Property Office on Jul. 2, 2014, the disclosure of which is incorporated herein by reference in its entirety.

### BACKGROUND

1. Technical Field

The present invention relates to a camera module.

2. Background Art

Generally, camera modules can be applied to portable electronic devices, such as mobile phones, digital cameras, camcorders, portable multimedia players, etc. Owing to the advancement of digital camera technologies and data storage capacities, an increasing number of camera modules having greater specifications are increasingly installed.

With the rapid technical development and popularity of various mobile devices having better portability and enhanced communication capability of voice and data, particularly with an increased propagation of next-generation communication terminals, there have been increased demands for small camera modules in order to utilize these small telecommunication terminals for video communication and photographing work.

While the camera modules become increasingly smaller, there has also been an increased requirement for manufacturing the camera modules with higher precision due to the expansion of their use. Particularly, various components of the camera modules need to be precisely aligned and have to be prevented from being twisted or deformed.

The related art of the present invention is disclosed in Korea Patent Publication No. 10-2009-0111616 (laid open on Oct. 27, 2009).

### SUMMARY

Embodiments of the present invention provide a camera module that can simplify assembly processes of a housing and a lens barrel.

Embodiments of the present invention provide a camera module having an engagement structure that can restrict a longitudinal displacement by having the housing and the lens barrel engaged with each other.

Here, the camera module can allow the lens barrel and the housing to be engaged with each other through a simple assembly process of rotating the lens barrel.

### BRIEF DESCRIPTION OF THE DRAWINGS

FIG. 1 is a perspective view showing a camera module in accordance with an embodiment of the present invention.

FIG. 2 is an exploded perspective view showing the camera module in accordance with an embodiment of the present invention.

FIG. 3 and FIG. 4 show an assembled state of the camera module in accordance with an embodiment of the present invention.

FIG. 5 is an exploded perspective view showing a camera module in accordance with another embodiment of the present invention.

### DETAILED DESCRIPTION

Hereinafter, certain embodiments of a camera module in accordance with the present invention will be described in detail with reference to the accompanying drawings. In describing the present invention with reference to the accompanying drawings, any identical or corresponding elements will be assigned with same reference numerals, and no redundant description thereof will be provided.

When one element is described to be “coupled” to another element, it does not refer to a physical, direct contact between these elements only, but it shall also include the possibility of yet another element being interposed between these elements and each of these elements being in contact with said yet another element.

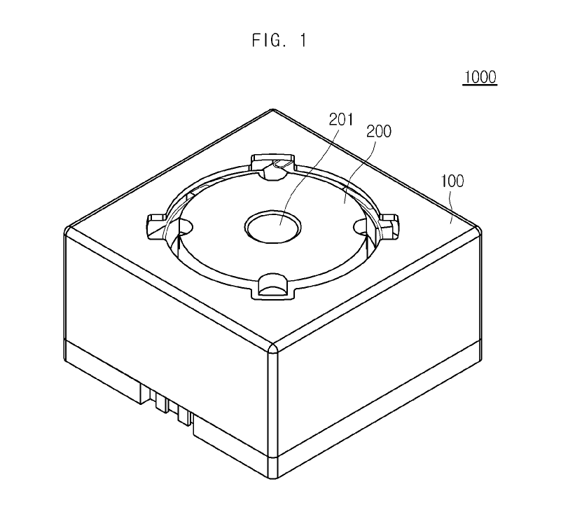

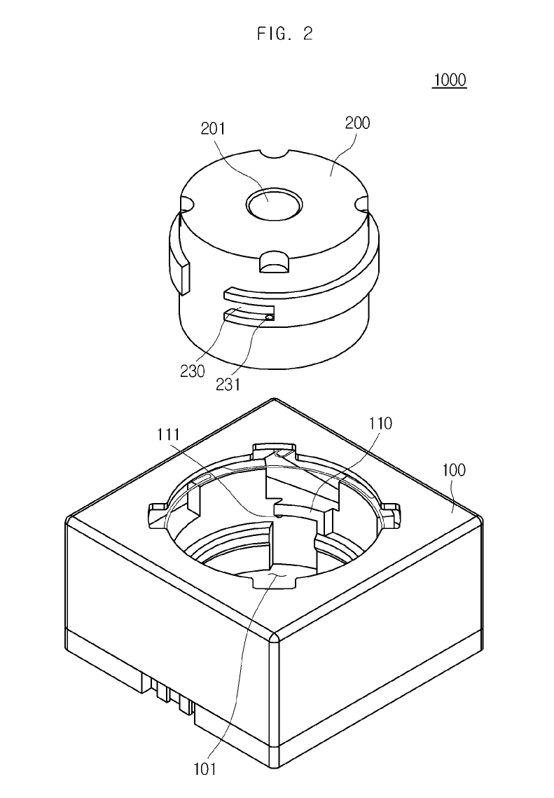

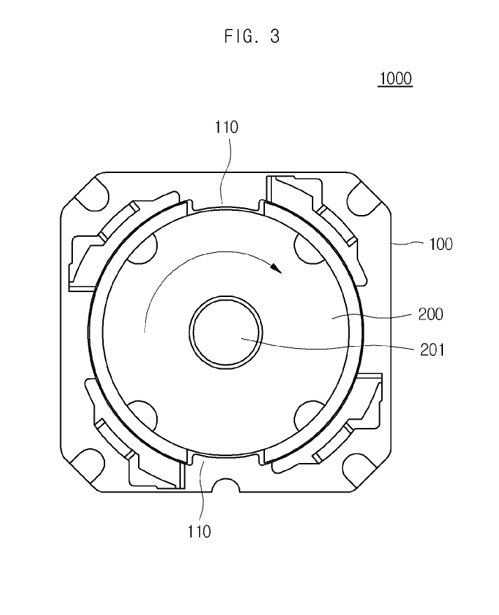

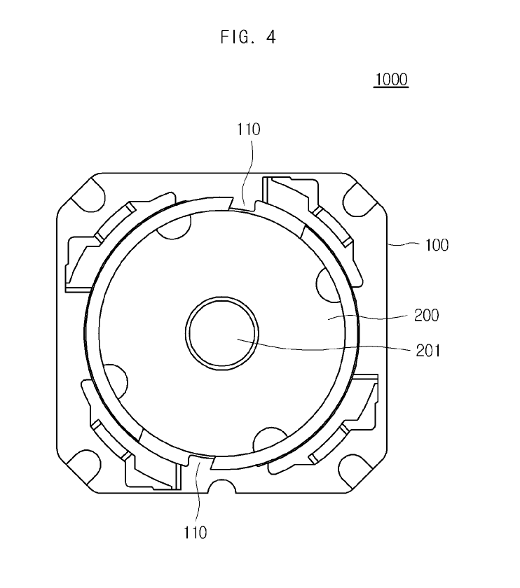

FIG. 1 is a perspective view showing a camera module in accordance with an embodiment of the present invention. FIG. 2 is an exploded perspective view showing the camera module in accordance with an embodiment of the present invention. FIG. 3 and FIG. 4 show an assembled state of the camera module in accordance with an embodiment of the present invention.

As illustrated in FIG. 1 to FIG. 4, a camera module 1000 in accordance with an embodiment of the present invention includes a housing 100 and a lens barrel 200.

The housing 100 is a portion having a receiving portion 101, in which the lens barrel 200 is received, formed therein and can constitute a main exterior of the camera module 1000 in accordance with the present embodiment. Particularly, the housing 100 can be constituted to cover a driver, which is configured for setting a focus by driving the lens barrel 200 up and down.

Moreover, the housing 100 can be configured to protect various internally-installed components of the camera module 1000 and to shield internally-generated electromagnetic waves from being emitted to an outside.

As illustrated in FIG. 1 to FIG. 4, the receiving portion 101 can be formed in the shape of a circular cylinder and can have an opening formed in a lower portion thereof so as to allow light to pass, but it shall be appreciated that the shape of the receiving portion is not restricted to what is described herein and can vary according to the shape of the lens barrel 200 and the use of the camera module 1000.

The housing 100 can have a printed circuit board coupled to a lower portion thereof, and an image sensor can be installed on the printed circuit board. The image sensor can be electrically connected to a circuit wiring of the printed circuit board, and a wiring of the image sensor can be flip chip bonded or soldered to the wiring of the printed circuit board.

The lens barrel 200 is inserted into the receiving portion 101, and a plurality of lenses are arranged along an optical axis in the lens barrel 200. The lens barrel 200 can have a lens hole 201 formed on an upper side thereof so as to allow light to be incident from the outside.

The lens barrel 200 can converge an image of a photographed image being incident through the lens hole 201 to the image sensor inside the camera module 1000 and can set the focus while being coupled to the driver and driven up and down.

Here, the receiving portion 101 can have a rib 110 formed on an inside surface thereof, and the lens barrel 200 can have an insertion groove 230 formed on an outside surface thereof in a latitudinal direction. Accordingly, the lens barrel 200 can be engaged with the housing 100 by inserting the rib 110 into the insertion groove 230.

Specifically, as illustrated in FIG. 2 to FIG. 4, the rib 110 can be a protrusion that is protruded on the inside surface of the receiving portion 101, and some or all of the rib 110 can be inserted into the insertion groove 230.

As illustrated in FIG. 2 to FIG. 4, the insertion groove 230 is a groove formed on the outside surface of the lens barrel 200, and the rib 110 and the insertion groove 230 can be engaged with each other by having the rib 110 inserted into the insertion groove 230.

Particularly, as the insertion groove 230 is formed in the latitudinal direction, longitudinal displacement of the rib 110 can be restricted when the rib 110 is inserted into the insertion groove 230. Accordingly, since the lens barrel 200 can be engaged with the housing 100 by inserting the rib 110 into the insertion groove 230, it is possible to prevent the lens barrel 200 from escaping from the housing 100.

Moreover, it is possible to overcome the difficulty of engaging the lens barrel 200 and the housing 100 with a specific mechanical height when the lens barrel 200 and the housing 100 are assembled by use of a screw thread structure, and thus the lens barrel 200 can be readily engaged with the housing 100 with a mechanical height specified in the design of the camera module 1000.

As described above, through the structure of the rib 110 and the insertion groove 230 that can restrict the longitudinal displacement when engaged with each other, the camera module 1000 in accordance with the present embodiment can be readily assembled and can prevent lowered reliability caused by disengagement of the lens barrel 200.

Although an example of the shapes of the rib 110 and the insertion groove 230 is illustrated in FIG. 2 to FIG. 4, the shapes of the rib 110 and the insertion groove 230 are not limited to what is illustrated herein and can vary as long as the rib 110 and the insertion groove 230 can be engaged with each other to restrict the longitudinal displacement.

Moreover, the rib 110 and the insertion groove 230 can be formed continuously or provide in discontinued plurality on the inside surface of the receiving portion 101 and the outside surface of the lens barrel 200. Moreover, it is possible to substitute the insertion groove 230 with an additional second rib that is formed on the outside surface of the lens barrel 200 to be symmetric with the rib 110 so as to be engaged with the rib 110.

In the camera module 1000 in accordance with the present embodiment, an external diameter of the lens barrel 200 can be formed to correspond to an internal diameter of the receiving portion 101, and one end of the insertion groove 230 can be formed to be open in longitudinal direction, in such a way that the rib 110 can be engaged with the insertion groove 230 by rotating the lens barrel 200 after the rib 110 is inserted into the one end of the insertion groove 230.

Hereinafter, an example of engaging the lens barrel 200 to the housing 100 will be described with reference to FIG. 3 and FIG. 4.

Since the external diameter of the lens barrel 200 is formed to correspond to the internal diameter of the receiving portion 101, the rib 110 can interfere with a portion of the lens barrel 200 when the lens barrel 200 is inserted into the receiving portion 101 from a top of the receiving portion 101.

Accordingly, as shown in FIG. 3, by having the rib 110 positioned where the one end of the insertion groove 230 is open in longitudinal direction, the lens barrel 200 can be inserted into the receiving portion 101 from the top of the receiving portion 101.

Meanwhile, since the longitudinal displacement of the rib 110 is not restricted in FIG. 3, the lens barrel 200 can be rotated until the state shown in FIG. 4 is reached.

Accordingly, as the rib 110 is slid into the insertion groove 230 to have the rib 110 and the insertion groove 230 engaged with each other, the longitudinal displacement of the rib 110 is eventually restricted.

As described above, in the camera module 1000 in accordance with the present embodiment, the lens barrel 200 and the housing 100 can be assembled through a simple process of inserting the lens barrel 200 from the top of the receiving portion 101 and rotating the lens barrel 200.

Especially, the rib 110 is not interfered with a portion of the lens barrel 200 when the lens barrel 200 is inserted into the receiving portion 101 through the top of the receiving portion 101, the receiving portion 101 and the housing 100 may not have to be manufactured to be large.

Accordingly, the camera module 1000 in accordance with the present embodiment can be made even smaller, improving the convenience and reliability of assembly.

In the camera module 1000 in accordance with the present embodiment, the rib 110 can have a locking protrusion 111, which is protruded in a longitudinal direction, formed thereon, and the insertion groove 230 can have a locking groove 231, which corresponds to the locking protrusion 111 when the housing 100 is engaged with the lens barrel 200, formed thereon.

That is, in the state of FIG. 4, the locking protrusion 111 formed on the rib 110 can be coupled with the locking groove 231 formed on the insertion groove 230. In such a case, the number and position of the locking protrusion 111 and the locking groove 231 may not be restricted to what are illustrated in FIG. 2 and can vary as necessary. For example, the locking protrusion 111 and the locking groove 231 can be each provided in plurality and separated by a predetermined distance.

As described above, in the camera module 1000 in accordance with the present invention, the locking protrusion 111 is coupled with the locking groove 231 while the housing 100 is engaged with the lens barrel 200, and thus the assembled lens barrel 200 can be prevented from unnecessary rotation.

The camera module 1000 in accordance with the present embodiment can have adhesive coated at a portion thereof where the receiving portion 101 and the lens barrel 200 are in contact with each other. In such a case, the adhesive can be coated and then cured at a portion where the receiving portion 101 and the lens barrel 200 make contact with each other to allow the lens barrel 200 and the housing 100 to be adhered to each other.

Here, the portion where the receiving portion 101 and the lens barrel 200 make contact with each other can be the rib 110 and the insertion groove 230, or an outermost surface of the lens barrel 200 and an inner circumferential surface of the receiving portion 101 that makes contact with the outermost surface of the lens barrel 200. Moreover, the adhesive may be coated entirely, or partially as necessary, on the portion where the receiving portion 101 and the lens barrel 200 make contact with each other.

Accordingly, it is possible to increase the engaging force between the lens barrel 200 and the housing 100 by supplementing the above-described rib 110 and insertion groove 230 structure. Moreover, since the adhesive can be partially fluid while having certain adhesive force before the adhesive is completely cured, a relative position between the lens barrel 200 and the housing 100 can be adjusted before the camera module 1000 is completely assembled.

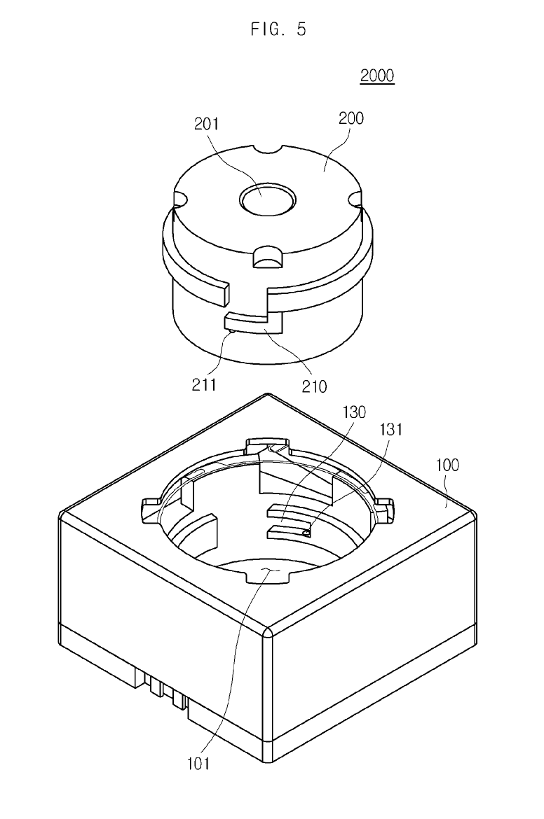

FIG. 5 is an exploded perspective view showing a camera module in accordance with another embodiment of the present invention.

As illustrated in FIG. 5, a camera module 2000 in accordance with another embodiment of the present invention includes a housing 100 and a lens barrel 200.

Here, the receiving portion 101 can have an insertion groove 130 formed on an inside surface thereof in a latitudinal direction, and the lens barrel 200 can have a rib 210 formed on an outside surface thereof. Accordingly, the lens barrel 200 can be engaged with the housing 100 by inserting the rib 210 into the insertion groove 130.

Specifically, as illustrated in FIG. 5, the insertion groove 130 is a groove that is formed on the inside surface of the receiving portion 101, and the rib 210 and the insertion groove 130 can be engaged with each other by having the rib 210 inserted into the insertion groove 130.

As illustrated in FIG. 5, the rib 210 is a protrusion that is protruded on the outside surface of the lens barrel 200, and some or all of the rib 210 can be inserted into the insertion groove 130.

Particularly, as the insertion groove 130 is formed in the latitudinal direction, longitudinal displacement of the rib 110 can be restricted when the rib 210 is inserted into the insertion groove 130.

As described above, through the structure of the rib 210 and the insertion groove 130 that can restrict the longitudinal displacement when engaged with each other, the camera module 2000 in accordance with the present embodiment can be readily assembled and can prevent lowered reliability caused by disengagement of the lens barrel 200.

In the camera module 2000 in accordance with the present embodiment, an external diameter of the lens barrel 200 can be formed to correspond to an internal diameter of the receiving portion 101, and one end of the insertion groove 130 can be formed to be open in longitudinal direction, in such a way that the rib 210 can be engaged with the insertion groove 130 by rotating the lens barrel 200 after the rib 210 is inserted into the one end of the insertion groove 130.

Accordingly, the camera module 2000 in accordance with the present embodiment can be made even smaller, improving the convenience and reliability of assembly.

In the camera module 2000 in accordance with the present embodiment, the rib 210 can have a locking protrusion 211, which is protruded in a longitudinal direction, formed thereon, and the insertion groove 130 can have a locking groove 131, which corresponds to the locking protrusion 211 when the housing 100 is engaged with the lens barrel 200, formed thereon.

Accordingly, in the camera module 2000 in accordance with the present invention, the locking protrusion 211 is coupled with the locking groove 131 while the housing 100 is engaged with the lens barrel 200, and thus the assembled lens barrel 200 can be prevented from unnecessary rotation.

The camera module 2000 in accordance with the present embodiment can have adhesive coated at a portion thereof where the receiving portion 101 and the lens barrel 200 are in contact with each other.

Accordingly, it is possible to increase the engaging force between the lens barrel 200 and the housing 100 by supplementing the above-described rib 210 and insertion groove 130 structure. a relative position between the lens barrel 200 and the housing 100 can be adjusted before the camera module 2000 is completely assembled.

Other than the above-described configurations of the camera module 2000 in accordance with another embodiment of the present invention, most main elements of the camera module 2000 in accordance with the present embodiment are either identical or similar to main elements of the camera module 1000 in accordance with an embodiment of the present invention, and thus will not be described redundantly herein.

Although certain embodiments of the present invention have been described above, it shall be appreciated that there can be a variety of permutations and modifications of the present invention by those who are ordinarily skilled in the art to which the present invention pertains without departing from the technical ideas and scope of the present invention, which shall be defined by the appended claims. It shall be also appreciated that a large number of other embodiments than the above-described embodiments are included in the claims of the present invention.

1. A camera module comprising:
a housing having a receiving portion formed therein, the receiving portion being longitudinally displaceable; and
a lens barrel being inserted into the receiving portion,
wherein a rib is formed on an inside surface of the receiving portion, and
wherein an insertion groove is formed on an outside surface of the lens barrel in a latitudinal direction and configured to engage with the housing by inserting the rib into the insertion groove to drive the lens barrel in a longitudinal direction with the displaceable receiving portion for local adjustment.

2. The camera module of claim 1, wherein an external diameter of the lens barrel is formed to correspond to an internal diameter of the receiving portion, and
wherein one end of the insertion groove is formed to be open in longitudinal direction in such a way that the rib is engaged with the insertion groove by inserting the rib into the one end of the insertion groove and then rotating the lens barrel.

3. The camera module of claim 2, wherein the rib has a locking protrusion, protruded in a longitudinal direction, formed thereon, and
wherein the insertion groove has a locking groove formed thereon at a position corresponding to the locking protrusion while the housing is engaged with the lens barrel.

4. The camera module of claim 1, wherein adhesive is coated at a portion where the receiving portion and the lens barrel are in contact with each other.

5. A camera module comprising:
a housing having a receiving portion formed therein, the receiving portion bring longitudinally displaceable; and
a lens barrel being inserted into the receiving portion,
wherein an insertion groove is formed on an inside surface of the receiving portion in an latitudinal direction, and
wherein a rib is formed on an outside surface of the lens barrel and configured to engage with the housing by inserting the rib into the insertion groove to drive the lens barrel in a longitudinal direction with the displaceable receiving portion for focal adjustment.

6. The camera module of claim 5, wherein an external diameter of the lens barrel is formed to correspond to an internal diameter of the receiving portion, and
wherein one end of the insertion groove is formed to be open in longitudinal direction in such a way that the rib is engaged with the insertion groove by inserting the rib into the one end of the insertion groove and then rotating the lens barrel.

7. The camera module of claim 6, wherein the rib has a locking protrusion, protruded in a longitudinal direction, formed thereon, and
wherein the insertion groove has a locking groove formed thereon at a position corresponding to the locking protrusion while the housing is engaged with the lens barrel.

8. The camera module of claim 5, wherein adhesive is coated at a portion where the receiving portion and the lens barrel are in contact with each other.

9. The camera module of claim 1, wherein a locking groove is disposed on a surface of the insertion groove and a locking protrusion is disposed on a surface of the rib, the locking groove being configured to fixedly couple with the locking protrusion.

10. The camera module of claim 5, wherein a locking groove is disposed on a surface of the insertion groove and a locking protrusion is disposed on a surface of the rib, the locking groove being configured to fixedly couple with the locking protrusion.

11. A camera module comprising:
a housing having a receiving portion formed therein, the receiving portion being longitudinally displaceable; and
a lens barrel being inserted into the receiving portion,
wherein complementary coupling members are formed on opposing surfaces of the receiving portion and the lens barrel, the coupling members being configured to fixedly couple the lens barrel with the receiving portion to transmit driving force to drive the lens barrel in a longitudinal direction with the displaceable receiving portion.

12. The camera module of claim 11, wherein the complementary coupling members comprise:
a capturing portion and a protrusive member respectively formed in one of the lens barrel and the receiving portion of the housing, wherein the capturing portion is configured to receive and operably couple with the protrusive member.

13. The camera module of claim 12, wherein the capturing portion comprises an insertion groove and the protrusive member comprises a rib, the insertion groove configured to latitudinally receive the protrusive member.

14. The camera module of claim 13, wherein the capturing portion comprises a substantially U-shaped member formed in a substantially annular ridge encircling a surface of one of the receiving portion or the lens barrel.

15. The camera module of claim 13, wherein the rib is disposed on an ear protruding longitudinally from a substantially annular ridge encircling a surface of one of the receiving portion or the lens barrel.

16. The camera module of claim 14, wherein the substantially annular ridge has a longitudinal passage defined therethrough, the longitudinal passage configured to allow longitudinal displacement of the rib member therethrough to align the rib for insertion into the insertion groove.

17. The camera module of claim 15, wherein a locking groove is disposed on a surface of the insertion groove and a locking protrusion is disposed on a surface of the rib, the locking groove being configured to fixedly couple with the locking protrusion.

18. The camera module of claim 15, wherein the insertion groove is configured at a longitudinal portion of the lens barrel according to a focal alignment of the lens barrel with an image sensor disposed thereunder.

19. The camera module of claim 15, wherein the rib is configured at a longitudinal portion of the lens barrel according to a focal alignment of the lens barrel with an image sensor disposed thereunder.
